(19) United States
(12) Patent Application Publication
(10) Pub. No.: US 2005/0067448 A1
(43) Pub. Date: Mar. 31, 2005

(54) Hook for attaching a portable tool to a carrying device

(76) Inventor: Leena Rundberg, Norrahammar (SE)

Correspondence Address: PEARNE & GORDON LLP, 1801 EAST 9TH STREET, SUITE 1200, CLEVELAND, OH, 44114-3108, US

(21) Appl. No.: 10/485,237

(22) PCT Filed: Jan. 16, 2002
(86) PCT No.: PCT/US02/01058

(30) Foreign Application Priority Data
May 31, 2001 (SE) 0101922-3

(51) Int. Cl. B65D 25/52; A01K 97/04; A01K 97/06; A45F 3/04

(52) U.S. Cl. 224/197; 224/640

(57) ABSTRACT

Engine powered tools that are carned in a harness on he operator must be easy to release from the harness if the rool is not working properly. The tool is hanging in a hook (14) that is secured to a hip pad (10) on the harness. The hook (14) is releasable from the hip pad (10) by a clip (13) that is opend in case of tool problems. When the clasp (13) is opened the tool will drop to the ground by the gravity.

Engine powered tools like for example clearing saws, trimmers and brush cutters are widely used for work in forests and gardens. The different types of tools are available in different sizes that are developed to meet the requirements for the work. The operator often works long shifts with the tool and the body of the operator will therefore be exposed to big loads.

In order to improve the working conditions for the operator are these tools carried in a harness placed on the back, shoulders and hip of the operator. The tool is attached to the harness by a hook placed on a hip pad that is haning down from the harness in a rope. The hip pad is during use placed close to one of the hips of the operator. The use of a harness for carrying the tool reduces the loads on the arms of the operator since most of the tool weight is carried by the back and the shoulders of the operator instead of the operator's arms that are used for the control of the tool. The hip pad is used to reduce the wear from the hook that is connected to the tool and to support the tool on the hip of the operator. The position of the hip pad is adjustable in order to suite operators with different length. The straps on the harness are also adjustable to be comfortable for the operator to wear.

Modern combustion engine powered tools are reliable ant polite but clearing saws and tiers are used in a rough environment where they are exposed to a lot of bumps during use. This means that the components are suffering a risk of being damaged. Damage of some of the components in the tool cause leakage of oil or fiel, which could lead to a break down of the tool or in the worst case that the tool starts burning.

The fuel and oil in the tool are highly inflammable and is therefore a risk for the operator if an accident occur. If the tool starts burning or there is a risk for an explosion must the operator be able to release the tool from the harness very quickly and without complicated actions.

The harnesses available on the market today are designed to meet the requirements in laws that regulates these kind of tools in order to guarantee the safety of the operator. These harnesses are designed so that the operator can open the harness by one single handle that should be placed so that it is easy for the operator to reach when the harness is in its right position on the operator. This means that when the operator opens the harness is will fall off the shoulders of the operator and down to the ground so that the operator gets free from the tool. A harness designed like this however has the drawback that it is very difficult to make it comfortable for the operator to wear.

New laws though replace the laws that the known harnesses are designed to meet. According to the new laws must it be possible to release the tool from the operator in an easy way instead of the tool and the harness like the previous laws slated.

The claimed invention solves the problem described above by providing the hook on the hip pad that the tool is attached to with a release mechanism so that the hook can be released from the hip pad if an accident occur. This solution makes it possible to design an ergonomic harness since the harness don't need to be removable from the operator when an accident happens to the tool.

The invention defined by the claims consists of a hook that the tool is attached to. The hook in fastened to the hip pad by a clasp that is easy for the operator to open if there is problems with the tool that could risk the safety of the operator. When the clasp is opened is the hook released from the hip pad and the tool will immediately drop to the ground by the gravity.

The hook is of the same type as the one used for earlier harnesses but the arrangement for fastening the hook to the hip pad is new. The hook has a loop to which a flat strap is permanently fastened. The strap is put between a clasp and a plate that are secured to the hip pad. When the strap is in its right position in the clasp is the strap pressed between the clasp and the plate so that it is secured in that position in the hip pad so that the harness carries the weight of the tool.

The part of the clasp that is pressing on the flat strap is disposed at the same component as the handle that the operator use for securing the hook to the hip pad and releasing the tool from thle harmess in case of an accident. The handle for opening the clasp is positioned so that it is pointing upwards to be easy for the operator to reach if there is a need for releasing the tool.

One embodiment of the claimed invention is illustrated in the figues.

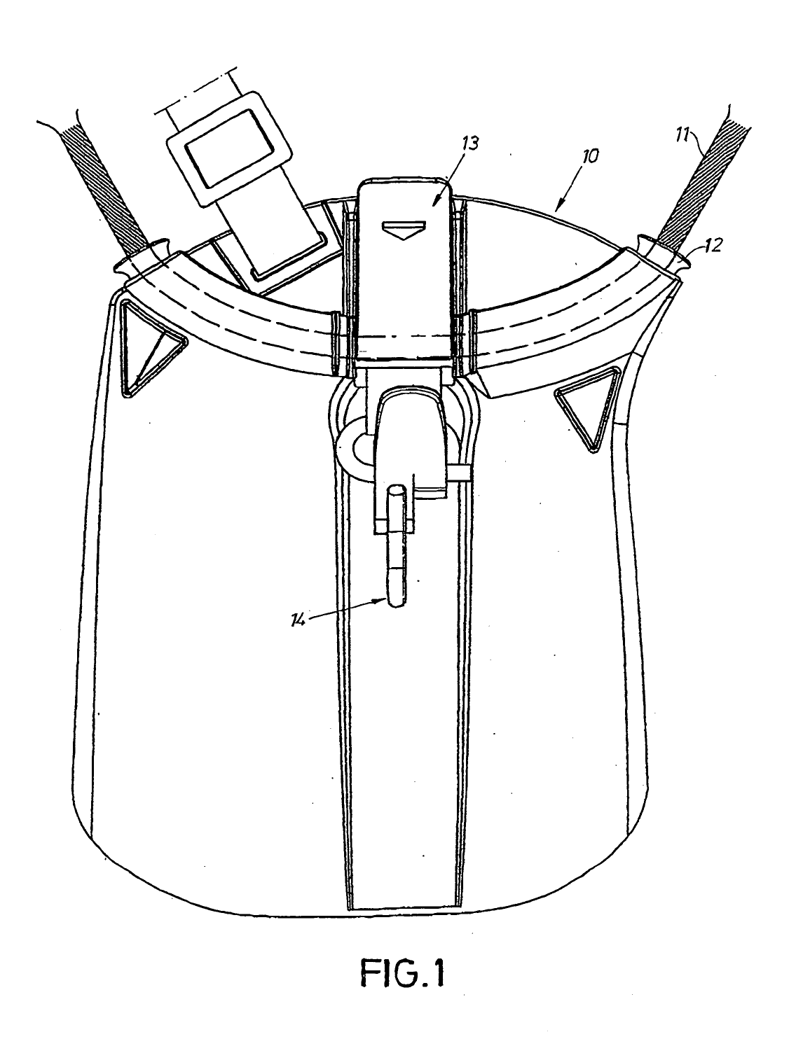

FIG. 1. Illustrates the claimed invention for fastening the hook to the hip pad.

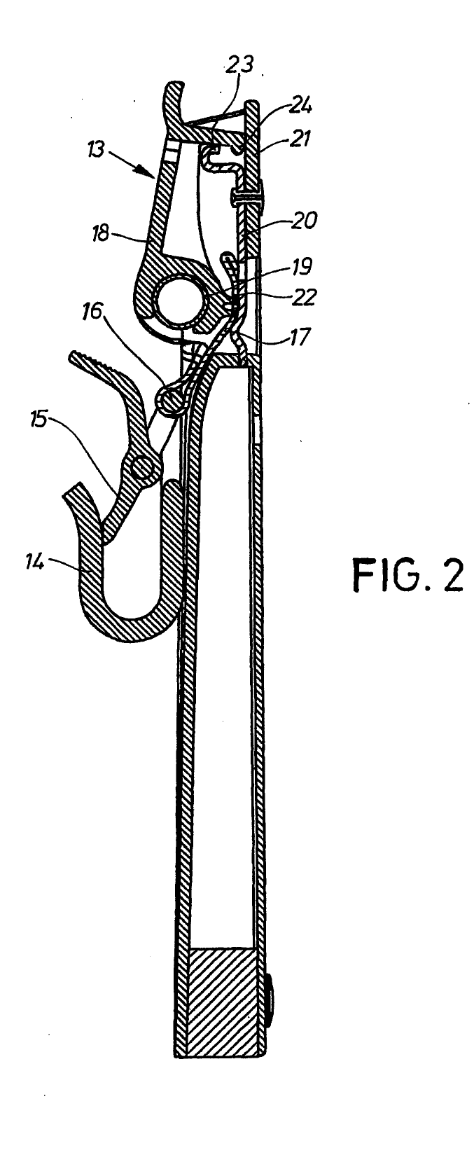

FIG. 2. Illustrates a cross section of the device in FIG. 1.

FIG. 1 illustrates a hip pad 10 that is banging down from a non-illustrated harness on a rope 11. The rope 11 is passing through a passage 12 in the top section of the hip pad 10 so that the hip pad 10 can slide along the rope 11 when the length of the rope 11 is changed to adjust the position of the hip pad 10 in relation to the operator. A clasp 13 is secured to the top half of the hip pad 10. A hook 14 for attaching the tool is secured in the clasp 13. This arrangement makes it possible for the operator to open the clasp 13 so that the hook 14 is released fiom its securing to the hip pad 10 and the harness and thereby falls down to the ground if the tool not is working properly and there is a risk for the safety of the operator.

The hook 14 includes a locking device 15 that prevents the tool from coming off the hook 14 unintentionally during use of the tool, and a loop 16 for securing of the tool to the hip pad 10 and the harness. The loop 16 is provided with a flat strap 17 that is fastened in a clasp 13 secured in the hip pad 10. The clasp 13 includes a component 18 that rotates around a hollow axle 19 and a plate 20 that is secured to the hip plate 10 in such a way that it aligns an inner layer 21 of the hip pad 10. One end of the component 18 is shaped like a pipe that surrounds almost the entire circmference of the hollow axle 21. The piped shaped section of the component 18 is on the side that faces outwards provided with a protruding flange 22 in the same direction as the axle 21. The flat strap 17 is placed between the plate 20 and the component 18 that is placed in the position where the clasp is open. When the flat strap 17 is in the right position is the component 18 rotated so that the flat strap 17 is pressed between the plate 20 and the protruding flange 22 on the component 18 and thereby secures the flat strap 17 and the hook 14 to the hip pad 10. The component 18 is rotated so that the handle section of the component is turned towards the hip pad 10.

If the tool not is working properly and there is a risk for the operator does the operator move the handle section of the component 18 outwards in relation to the hip pad 10.

The flat strap 17 will then be released from the securing between the plate 20 and the protruding flange 22 so that the tool immediately drops to the ground

The plate 20 is in the top end bent so that there is a protruding edge 23. The outer end of the handle section of the component 18 is shaped like a small hook 24 that connects to the protruding edge 23 when the clasp 13 is in the position where the hook 14 is secured to the hip pad 10. This arrangement prevents unintended release of the hook 14 and the tool from hip pad 10.

1. A device for attaching a hook (14), that is supporting a portable tool, to a hip pad (10) that is hanging down from a harness, characterised in that the hook (14) is attached to the hip pad (10) via a clasp (13) that could be opened so that the hook (14) is released from the hip pad (14).

2. A device according to claim 1, characterised in that the hook (14) is provided with a strap (17) that is fastened in the clasp (13) secured to the hip pad (10).

3. A device according to claim 2, characteiised in that the strap (17) is pressed between different parts of the clasp (13).

4. A device according to claim 3, characterised in that clasp (13) comprises a component (18) that is rotated around an axle (19) and a plate (20) secured in the hip pad (10)

5. A device according to claim 4, characterised in that the section of the component (18) that surrounds the axle (I9) is provided with a protruding flange (22) in the same direction as the axial direction of the axle (19).

6. A device according to claimr 5, characterised in that the strap (17) is pressed between the protruding flange (22) on the component (18) and the plate (20) so that the strap (17) is secured in the clasp (13).

7. A device according to claim 4, 5 or 6, characterised in that the hook (14) is released from the hip pad (10) by rotating the component (18) outwards in relation to the hip pad (10) around the axle (19) so that the pressure on the strap (17) disappear and the strap is released.

8. A device according to claim 4, 5, 6 or 7, characterised in that the end of the component (18) that not is connected to the axle (19) is provided witb a small hook (24) that connects to a protruding part (23) in the end of the plate (20) so that the clasp (13) not is opened unintentionally.
